(19) United States
(12) Patent Application Publication
(10) Pub. No.: US 2007/0114381 A1
(43) Pub. Date: May 24, 2007

(54) Charged particle harvesting

(76) Inventor: Gerald P. Jackson, Lisle, IL (US)

Correspondence Address: PETER K. TRZYNA, ESQ., P O BOX 7131, CHICAGO, IL, 60680, US

(21) Appl. No.: 11/593,245

(22) Filed: Nov. 6, 2006

Related U.S. Application Data
(60) Provisional application No. 60/734,126, filed on Nov. 7, 2005.

(51) Int. Cl. B01D 59/44

(52) U.S. Cl. 250/284

(57) ABSTRACT

Particle harvesting apparatus and method. The apparatus can include at least one electric field configured to separate charged particles and to confine some of the charged particles. The apparatus can be used to separate desired charged particles from other particles, for example, in space. The apparatus can reduce kinetic energies of the desired charged particles, and can store the desired charged particles.

### I. CONTINUITY STATEMENT

This is a continuation-in-part, claiming priority from, and incorporating by reference, the following patent applications: “Electrostatic Bottle for Charged Particle Storage” Ser. No. 60/731,971, filed Oct. 31, 2005; “Antimatter Harvesting in Space,” Ser. No. 60/734,126, filed Nov. 7, 2005; and U.S. Patent Application titled “Containing/Transporting Charged Particles,” naming as inventor Gerald P. Jackson, filed on Oct. 30, 2006, and having express mail label EQ139851562US. Incorporated by reference are: “Particle Beam Processing System,” U.S. Pat. No. 6,838,676, naming as inventor Gerald P. Jackson, issued on Jan. 4, 2005; and “Deceleration of Hadron Beams in Synchrotrons Designed for Acceleration,” U.S. Pat. No. 6,822,405 naming as inventor Gerald P. Jackson on Nov. 23, 2004.

### II. BACKGROUND OF THE INVENTION

A. Field of the Invention

Embodiments herein relate to the field of charged particle separation, accumulation, storage, and/or use. More particularly, embodiments relate to apparatus and method of collecting and storing charged particles. More specifically, embodiments relate to collection and storage of antiprotons; and the use of antiprotons.

### III. BRIEF DESCRIPTION OF THE DRAWINGS

FIG. 1 is a schematic representation of an embodiment.

FIG. 2 is a schematic representation of the constituent charged particles in space.

FIG. 3 is an illustrative example of the trajectories of solar wind protons.

FIG. 4 is an illustrative example of the trajectories of solar wind electrons.

FIG. 5 is the measured flux of antiprotons in space near the Earth.

FIG. 6 is the measured flux of positrons in space near the Earth.

FIG. 7 is an illustrative example of the reflection of desired and scattering particles back into the cooling region.

FIG. 8 is a schematic representation of manipulation and use of charged particles extracted from a harvester.

### IV. MODES

Space is not a vacuum. It contains protons, electrons, and charged ions emanating from the sun in the solar wind. It contains dust. It contains cosmic rays that travel through our solar system at tremendous energies. It also contains stable secondary particles formed in the collisions between these cosmic rays, planetary atmospheres, dust, and the solar wind. Some of these particles can be used by space explorers for air, water, and fuel. Therefore, the ability to harvest (i.e., separate, confine, and then store) these charged particles has economic and survival value. Of particular interest is the harvesting of antiprotons.

Embodiments herein address the collection and storage of positrons; and/or the transport and use of antiprotons. Embodiments herein address the collection and storage of ions in the solar wind.

Antiprotons can be generated and used in experimental studies typically performed by using large particle accelerators, such as the Tevatron at the Fermi National Accelerator Laboratory (Fermilab). The Fermilab accelerator complex includes various linear accelerators and synchrotrons to generate antiprotons, to accelerate these antiprotons to very high energies and momenta (typically to 1TeV), and to collide these antiprotons together with protons. The results of the collisions can be analyzed to provide information regarding the structure and physical laws of the universe.

While these experimental studies of particle physics use antiprotons with very high energies and momenta, other uses of antiprotons, such as the medical use, have relatively small energies and momenta. If the existing sources of antiprotons at such accelerators are to be used as sources of antiprotons for these other fields, the antiprotons have to be decelerated (i.e., energy and momentum of the antiprotons will have to be reduced). Consider the use of the Main Injector at the Fermi National Accelerator Laboratory (FNAL) in Batavia, Ill. as a particle decelerator (instead of its nominal role as an accelerator), and incorporated by reference are U.S. Pat. Nos. 6,838,676 and 6,822,045. In addition, to provide antiprotons to locations that are off-site from the particle accelerators, the antiprotons have to be decelerated sufficiently to enable them to be stored in a portable synchrotron or cyclotron, or trapped in a bottle and transported to other locations.

Consider at least two embodiments that can be implemented separately or in cooperation to harvest antiprotons and/or positrons. The first embodiment harvests antiprotons found in space and the upper levels of the Earth's (or other planet's) atmosphere. Another embodiment harvests positrons found in space and the upper levels of the Earth's (or other planet's) atmosphere. In an illustrative implementation, an apparatus is a harvester located in space or upper levels of the Earth's (or other planet's) atmosphere, where the apparatus collects and stores antiprotons (first embodiment) and/or positrons (other embodiment), though the principles disclosed herein can be used otherwise depending on the implementation desired.

Consider at least three embodiments that can be implemented separately or in cooperation to harvest protons, electrons, and/or oxygen ions. The first of these embodiments harvests protons found in space and the upper levels of the Earth's (or other planet's) atmosphere, storing the protons and/or electrons in the form of molecular hydrogen. The second of these embodiments harvests oxygen ions and/or electrons found in space and the upper levels of the Earth's (or other planet's) atmosphere, storing the oxygen ions and electrons in the form of molecular oxygen. The third of these embodiment harvests protons, electrons, and/or oxygen ions found in space and the upper levels of the Earth's (or other planet's) atmosphere, storing them in the form of water.

In an illustrative implementation, an apparatus is a harvester located (or locatable) in space or upper levels of the Earth's (or other planet's) atmosphere, where the apparatus collects and stores protons and/or oxygen, e.g., along with electrons, though the principles disclosed herein can be used otherwise depending on the implementation desired.

By way of a prophetic teaching, the charged particle can be manipulated by a harvester implemented as nested spherical electrodes each comprised of a sparse mesh of wires (or the like). In an alternative electrode geometry, a harvester can be implemented as nested coaxial cylindrical electrodes each comprised of a sparse mesh of wires. Yet another alternative electrode geometry can be viewed as a harvester implemented as nested toroidal electrodes each comprised of a sparse mesh of wires.

Representatively, another way of viewing the teachings herein is an apparatus and/or method of harvesting and then storing charged particles, wherein the storing is devoid of a cryogenic temperature and/or a container with a cold wall, (and associated thermally conductive supports in thermal connection with said cold wall), and/or dewar associated with the container or need therefore. Compare this view with “Container for Transporting Antiprotons,” U.S. Pat. No. 5,977,554 issued to Gerald A. Smith, et al. on Nov. 2, 1999 and “Container for Transporting Antiprotons,” U.S. Pat. No. 6,160,263 issued to Gerald A. Smith, et al. on Dec. 12, 2000, both incorporated by reference. In the teachings herein a vacuum is maintained through any of a number of means, including gettering, ion-sputter pumping, and the employment of an envelope vacuum, or simply leaving the stored particles in the substantial vacuum of outer space. The realization that cold walls and cryogenic temperatures used in Penning traps are not required leads to important improvements in harvester weight and size.

Representatively, yet another way of view the teachings herein is an apparatus and/or method of harvesting, and then storing charged particles, wherein the storing is devoid of apertures or moveable components. Compare this view with “Container for Transporting Antiprotons,” U.S. Pat. No. 5,977,554 issued to Gerald A. Smith, et al. on Nov. 2, 1999;

“Container for Transporting Antiprotons,” U.S. Pat. No. 6,160,263 issued to Gerald A. Smith, et al. on Dec. 12, 2000; and “System for the Storage and Transportation of Anti-Matter,” U.S. Pat. No. 6,606,370, issued to Lukas Kasprowicz on Aug. 12, 2003, the latter incorporated by reference. In the teachings herein the electrodes can be comprised of a sparse mesh of wires, or a very thin membrane of material through which the charged particles can penetrate, that allow the vast majority of charged particles to enter the region of storing.

Representatively, yet another way of view the teachings herein is an apparatus and/or method of harvesting, and then storing charged particles, wherein the storing is devoid of structures that are of a dish-shaped or in a Cassegrain configuration. Compare this view with “Deployable Particle Collector for Space Particle Instruments,” U.S. Pat. No. 6,683,311, issued to Martin Peter Wuest on Jan. 27, 2004 and “Large Aperture Particle Detector with Integrated Antenna,” U.S. Pat. No. 5,962,850, issued to Martin Peter Wuest on Oct. 5, 1999, where both are incorporated by reference.

By way of a prophetic teaching, consider an embodiment in which antiprotons and positrons are each directed into a common mass of antihydrogen. In this embodiment with antihydrogen formation, there need be no use of electrons, protons, or other forms of normal matter. Compare this view with “Process for the Production of Antihydrogen,” U.S. Pat. No. 6,163,587, issued to Eric Arthur Hessels on December 19 and “Process for Preparing Antihydrogen,” U.S. Pat. No. 4,867,939, issued to Bernhard I. Deutch on Sep. 19, 1989, where both are incorporated by reference.

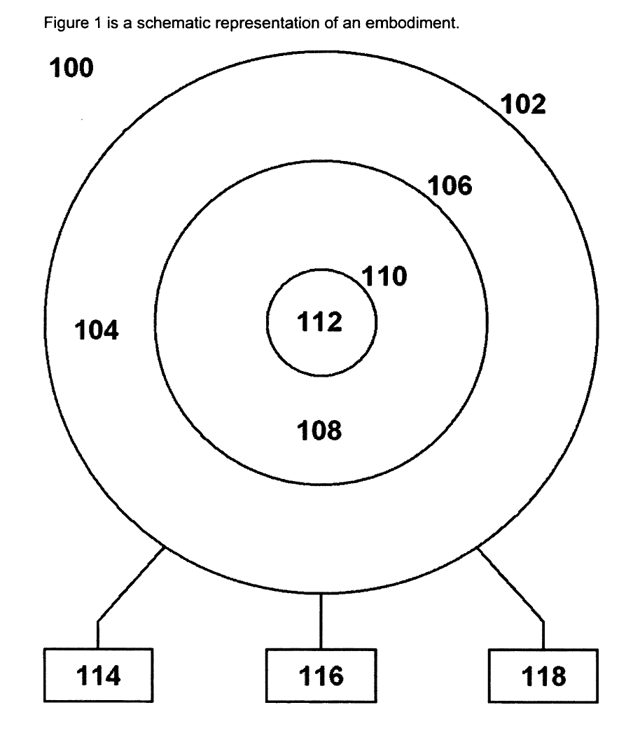

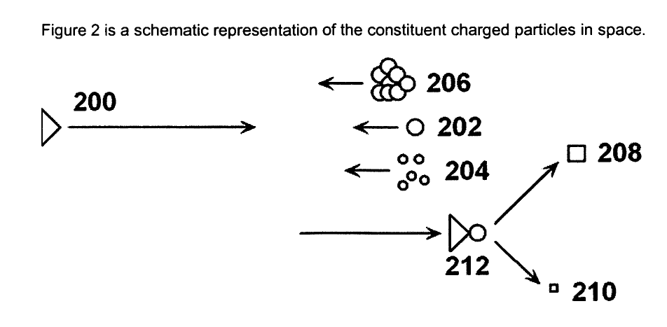

FIG. 1 contains a schematic representation of a charged particle harvester in outer space 100. As shown in the schematic representation in FIG. 2, the contents of outer space includes a variety of types of charged particles. While cosmic rays 200 come from outside the solar system, most of the protons 202, electrons 204, and atomic ions 206 come from the sun in the form of the solar wind. In the neighborhood of planetary bodies, the protons 202, electrons 204, and ions 206 can also originate from solar ionization of planetary atmospheres. In outer space there can also be found antiprotons 208 and positrons 210, which are believed to be generated by collisions between cosmic rays 200 and the other particles, dust, and planetary atmospheres.

In FIG. 2 a collision between a cosmic ray 200 and a solar wind proton 202 is illustrated in a teaching manner.

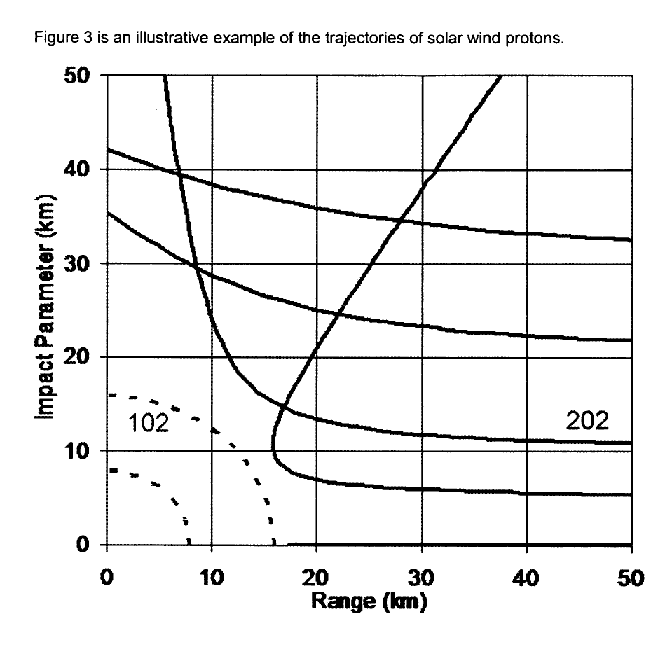

An apparatus for, and a method of, harvesting and/or storing charged particles is illustrated in a teaching manner. Harvesting includes separating the desired charged particles from unwanted particles. The two mechanisms for this separation can be particle charge and particle kinetic energy. Separation by charge can be accomplished by one or more outer electrodes 102 at an outer periphery of the harvester. If the harvester has a sufficiently large net charge, the electric field generated by this net charge will emanate out into space 100 and repel charged particles of the same sign. As an illustrative example of an embodiment of this invention, FIG. 3 shows the trajectories of solar wind protons 202 approaching the outer electrodes 102 from the right in a situation where the net charge of the harvester is positive. Note that the proton trajectories either reverse or deflect away from the harvester. As an illustrative teaching, when most of the solar wind protons 202 have kinetic energies of 10 MeV or below, an electrical potential of positive 10 MeV or more at the outermost electrode 102 can achieve this functionality. Note that this reversal or deflection of solar wind protons can be a source of propulsion for the harvester.

For opposite sign charged particles that are also unwanted, charge on either a second layer electrode within the outer electrode or the next layer of electrodes 106 lower within the harvester will generate an electric field in the region, in the latter case region 104, that will locally reflect those particles.

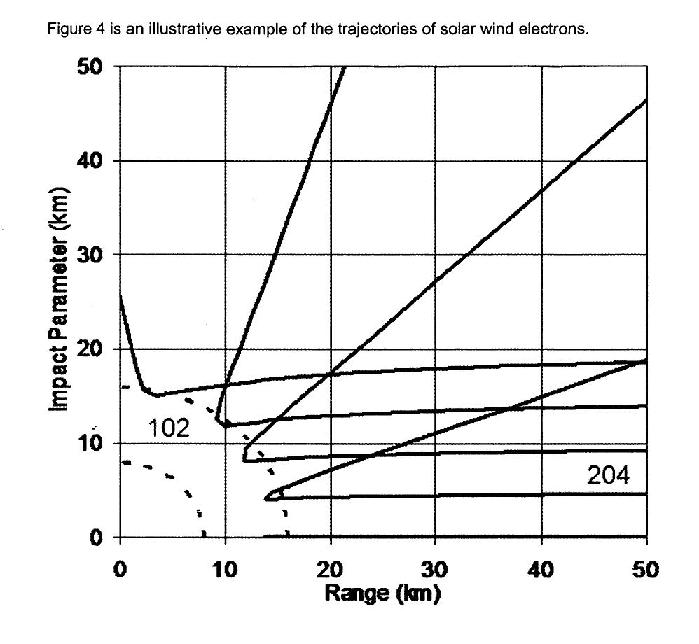

As a continuation of the illustrative example in the previous paragraph, FIG. 4 shows the trajectories of solar wind electrons 204 approaching the outer electrodes 102 from the right in a situation where the charge on all the layers beneath the inner of the two shown electrode layers is negative. As an illustrative teaching, when most of the solar wind electrons 204 have kinetic energies of 10 MeV or below, and electrical potential of −10 MeV or more negative at the surface of the innermost of the two shown electrodes 102 will achieve this functionality. Note that this reversal or deflection of solar wind electrons can be a source of propulsion for the harvester.

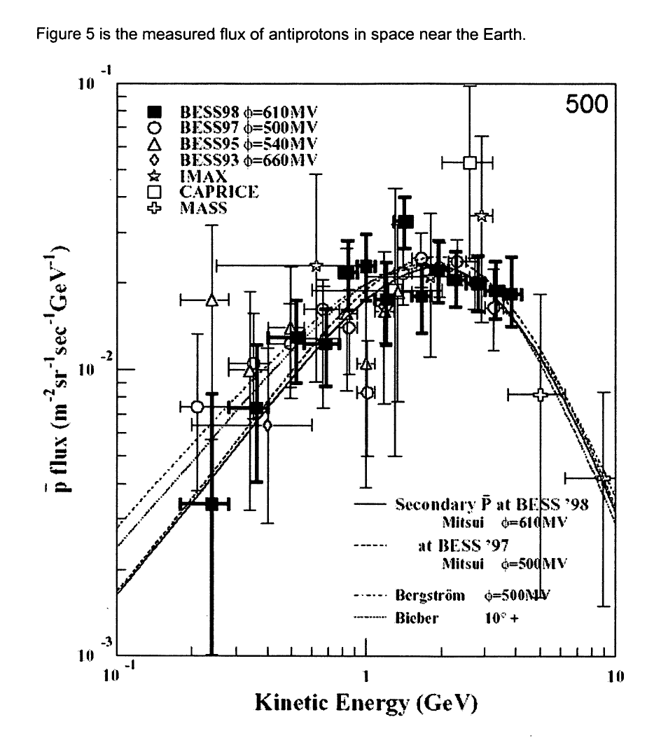

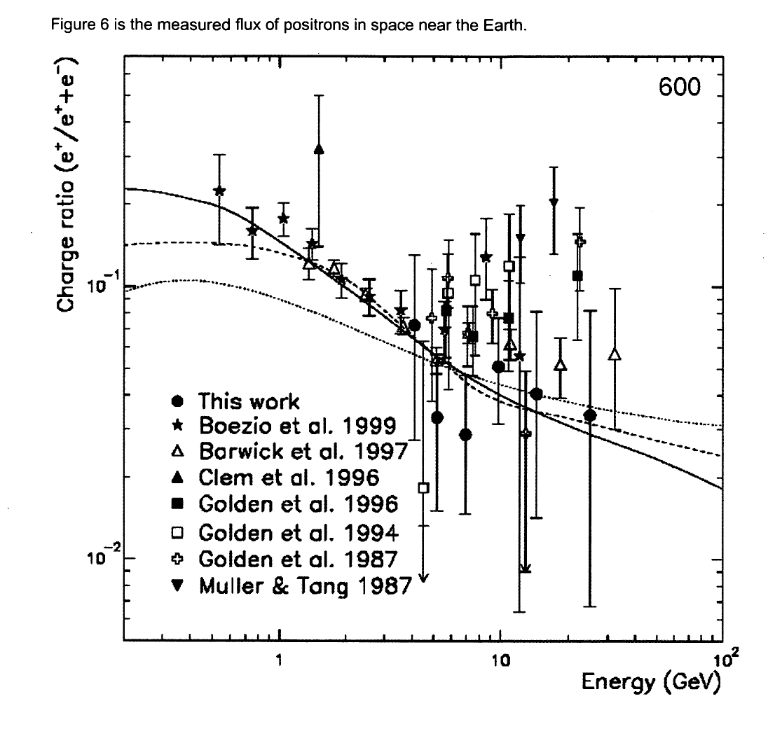

When the harvester is configured to reflect both signs of charged particles, the desired charged particles can enter the harvester with an initial kinetic energy greater than the barrier potentials described in the previous two paragraphs. As an illustrative teaching, consider the antiproton kinetic energy distribution 500 and relative positron kinetic energy distribution 600 shown in FIGS. 5 and 6, respectively. Note that in both cases the kinetic energy distributions are near their peaks above 1 GeV. An electrode 106 biased to an electrical potential of 1 GeV (either positive for positrons or negative for electrons) by setting the net charge within its radius to achieve this electrical potential will allow only particles above 1 GeV to traverse its boundary.

The other benefit of this situation is that the particles traversing the boundary of this electrode 106 and entering the region within 108 will have a kinetic energy distribution shifted downward by the value of that surface electrical potential. This reduction in kinetic energy is the first step in preparing the desired charged particles for eventual storage.

In this region 108 of decelerated desired charged particles, a number of mechanisms can be used to further reduce the kinetic energies of the desired charged particles. As an illustrative example, if the region is populated with electrons, the desired particles scatter against these electrons and slow down, a procedure sometimes called electron cooling. As another illustrative example, if the region is populated with positrons, the desired particles scatter against these positrons and slow down, a procedure sometimes called positron cooling.

As yet another illustrative example, if the region is populated with ions (either of normal matter or antimatter), the desired particles scatter predominantly against the electrons orbiting the nuclei and slow down, a effect called ionization cooling. As another illustrative example, if one or more electrodes have their electric charge modulated, stochastic cooling can be implemented.

In an embodiment in which both the desired particle and the scattering particle have the same sign electrical charge, the duration and amount of scattering can be greatly increased by electrically reflecting these particles back into the cooling region 108. As an illustrative example, this can be accomplished by composing the deceleration layer 106 with two separate electrodes.

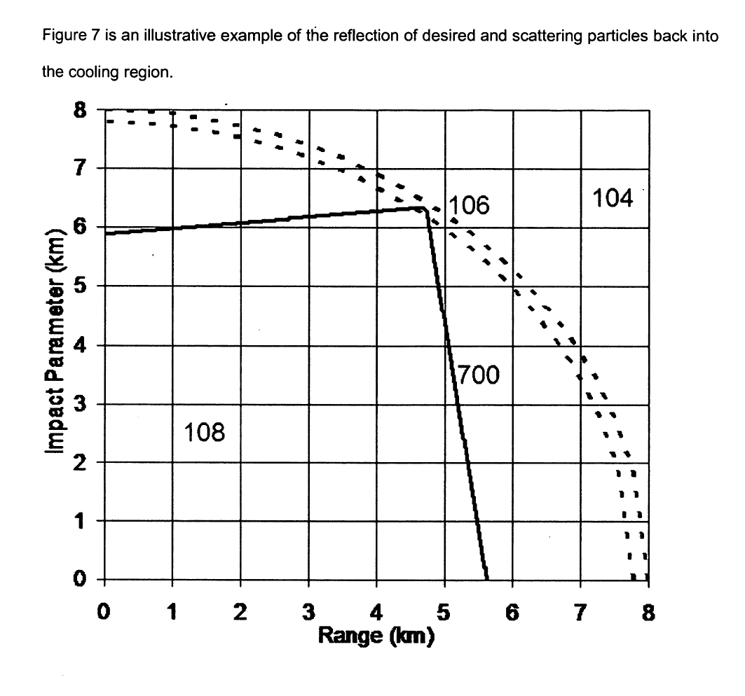

FIG. 7 is an illustrative example of the calculated trajectories of both desired and scattering charged particles 700 that approach the deceleration electrodes 106. By adjusting the electrical charges on these two electrodes to create an inward electrical force on both of the desired and scattering particles 700, they are both 700 reflected back into the cooling region 108.

Once the desired charged particles are sufficiently cooled, they can be stored in the region 112 inside the innermost electrode 110. This electrode is charged with the opposite sign of the desired charged particle in order to attract these slower particles into the storage region 112. This innermost electrode 110 can be composed of a mesh of wires. In another embodiment, this innermost electrode 110 can be composed of a membrane thin enough to allow the desired particle to traverse the membrane and enter the storage region 112.

Attached to the harvesting apparatus is at least one power source 114. In one embodiment, this power source 114 gathers its primary energy from solar radiation. In another embodiment, this power source 114 is based on nuclear energy. In yet another embodiment, this power source 114 is based on energy gathered from the decay of radioisotopes. While the power source 114 in FIG. 1 is shown connected to the outer electrodes 102, other embodiments are possible in which one or more power sources 114 are connected to other electrodes within the harvesting apparatus.

In one embodiment, the overall net charge of the harvesting apparatus is adjusted with a charged particle accelerator 116 which sends charged particle into space, away from the harvester. In another embodiment, the overall net charge of the harvesting apparatus is adjusted with a charged particle collector 118 which captures charged particles that approach or enter the harvester from space. In yet another embodiment, a combination of a charged particle accelerator 116 and a charged particle collector 118 are employed. As a prophetic teaching, the accelerated and/or captured charged particles are electrons. While the charged particle accelerator 116 and charged particle collector 118 in FIG. 1 are shown connected to the outer electrodes 102, other embodiments are possible in which one or more accelerators 116 and/or collectors 118 are connected to other electrodes within the harvesting apparatus.

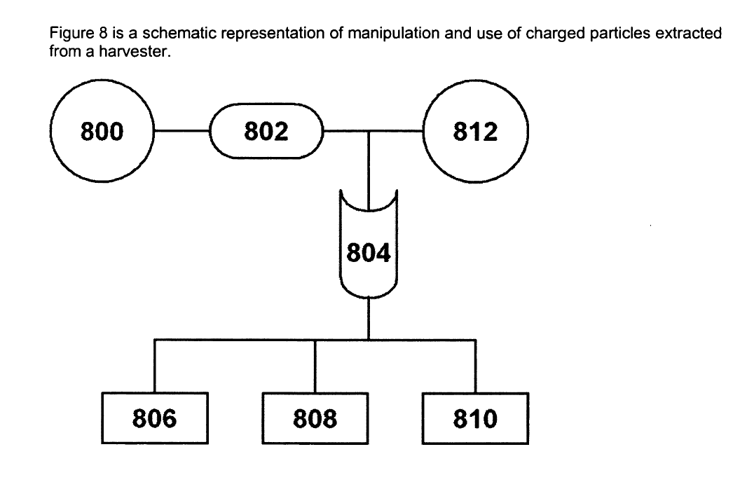

As shown in the schematic illustration in FIG. 8, charged particles can be extracted from a harvesting apparatus 800. In one embodiment, the extracted charged particles 802 are extracted by modifying the electric field in and around the harvester without a container. The extracted charged particles 802 can be in the form of a distribution of separate particles. Alternatively the extracted charged particles 802 can be extracted as a cohesive mass of molecules. At a distance removed from the harvesting apparatus a catcher 804 can be employed. The catcher 804 can be us used to store and transport these charged particles 802, or can direct them to a device that uses them. In another embodiment, the charged particles 802 are inside a container, and the container itself I extracted from the harvesting apparatus 800 and directed toward a catching apparatus 804 that directs the container to a device that uses the charged particles 802. In either case, the extracted charged particles 802 exit the harvesting apparatus 800 through the wire mesh composing the electrodes (for example, the outer electrode layer 102) without the use of openings or moveable closures.

The desired charged particles can be used as a fuel by a vehicle, such as a satellite 806 or rocket 806 or other space vehicle 806, via power plants using such particles (e.g., harvested hydrogen) to propel or power the vehicle. The desired charged particles can also be used as a fuel for power generation systems 808. The desired particles can also be used for air and/or water for people 810 in space. Also, consider an embodiment in which the harvested charged particles in one harvester 800 are extracted and captured and used in a second harvesting apparatus 812 wherein a second species of desired charged particle is harvested.

Note that the foregoing is a prophetic teaching and although only a few exemplary embodiments have been described in detail herein, those skilled in the art will readily appreciate from this teaching that many modifications are possible, based on the exemplary embodiments and without materially departing from the novel teachings and advantages herein. Accordingly, all such modifications are intended to be included within the scope of the defined by claims. In the claims, means-plus-function claims are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

1. Particle harvesting apparatus comprising:
at least one electric field configured to confine some charged particles separated from others by the field.

2. The apparatus of claim 1, wherein the electric filed is located in solar wind.

3. The apparatus of claim 1, wherein the at least one electric field is produced by electrodes that are each spherically shaped.

4. The apparatus of claim 3, wherein the electrodes are comprised of wire mesh.

5. The apparatus of claim 1, wherein the at least one electric field is produced by electrodes that are each comprised of two or more wires arranged as lines of longitude approximating a spherical shape.

6. The apparatus of claim 1, wherein the at least one electric field is produced by electrodes that are cylindrically shaped.

7. The apparatus of claim 5, wherein the electrodes are comprised of wire mesh.

8. The apparatus of claim 1, wherein the at least one electric field is produced by electrodes that are toroidally shaped.

9. The apparatus of claim 7, wherein the electrodes are comprised of wire mesh.

10. The apparatus of claim 1, wherein said at least one electric field is only one electric field.

11. The apparatus of claim 1, wherein the said at least one electric field configured to separate the charged particles from at least one of electrons, protons, or ions.

12. The apparatus of claim 1, further including stochastic cooling means configured to reduce kinetic energy of the captured particles.

13. The apparatus of claim 1, further including electron cooling means configured to reduce kinetic energy of the captured particles.

14. The apparatus of claim 1, further including positron cooling means configured to reduce kinetic energy of the captured particles.

15. The apparatus of claim 1, further including ionization cooling means configured to reduce kinetic energy of the captured particles.

16. The apparatus of claim 15, wherein the ionization cooling means includes antihydrogen means configured to cool the captured particles.

17. The apparatus of claim 1, further including two electrodes that produce said at least one electric field.

18. The apparatus of claim 17, wherein the two electrodes are each comprised of wire mesh.

19. The apparatus of claim 1, further including a vehicle adapted to use the captured particles as fuel.

20. Apparatus harvesting charged particles, the apparatus comprising:
an electric field generated by one or more electrodes configured to separate desired charged particles from unwanted charged particles, the electric field reducing kinetic energies of the desired charged particles and including a region storing the desired charged particles.

21. The apparatus of claim 20, wherein the desired particles include antiprotons.

22. The apparatus of claim 20, wherein the desired particles include positrons.

23. The apparatus of claim 20, wherein the desired particles include protons.

24. The apparatus of claim 20, wherein the desired particles include electrons.

25. The apparatus of claim 20, wherein the desired particles include ions.

26. Apparatus comprising:
an electric field harvesting charged particles separated from solar wind.

27. The apparatus of claim 26, further including a vehicle using the harvested charged particles as fuel.

28. Apparatus comprising:
at least one electric field electric field decelerating and confining charged particles separated from other charged particles in solar wind by the electric field.

29. A method of harvesting particles, the method comprising:
decelerating and confining charged particles separated from other charged particles in solar wind.

30. The method of claim 29, wherein the confined particles include antiprotons.

31. The method of claim 29, wherein the confined particles include positrons.

32. The method of claim 29, wherein the confined particles include protons.

33. The method of claim 29, wherein the confined particles include electrons.

34. The method of claim 29, wherein the confined particles include ions.

35. A method of making fuel, the method comprising:
providing at least one electric field configured to separate charged particles and to decelerate and capture some of the charged particles to produce fuel.

36. A method of harvesting particles, the method comprising:
harvesting subatomic particles separated from solar wind.

37. A method of harvesting particles, the method comprising:
separating some charged particles from other charged particles;
reducing the kinetic energies of said some of the charged particles; and
storing said some of the desired charged particles.

38. The method of claim 37, wherein the separating includes separating said some charged particles from the other charged particles in solar wind.

39. The method of claim 37, wherein the other charged particles include at least one of a group comprising electrons, protons, and ions.

40. The method of claim 37, wherein said some charged particles comprise antiprotons.

41. The method of claim 37, wherein said some charged particles comprise positrons.

42. The method of claim 37, wherein said some charged particles comprise protons.

43. The method of claim 37, wherein said some charged particles comprise electrons.

44. The method of claim 37, wherein said some charged particles comprise ions.

45. The method of claim 37, wherein the reducing the kinetic energies includes stochastic cooling.

46. The method of claim 37, wherein the reducing the kinetic energies includes electron cooling.

47. The method of claim 37, wherein the reducing the kinetic energies includes positron cooling.

48. The method of claim 37, wherein the reducing the kinetic energies includes ionization cooling.

49. The method of claim 37, wherein the reducing the kinetic energies includes ionization cooling with antihydrogen.

50. The method of claim 49, wherein the antihydrogen comprises molecular antihydrogen.

51. The method of claim 37, wherein the storing said some of the desired charged particles includes storing antiprotons and positrons by:
directing the antiprotons and positrons into a mass of molecular antihydrogen; and
forming additional antihydrogen.

52. The method of claim 37, wherein the reducing the kinetic energies includes ionization cooling with water molecules.

53. The method of claim 52, wherein storing of harvested protons, oxygen ions, and electrons can be implemented by directing the protons, oxygen ions, and electrons into a container of water molecules and forming additional water.

54. The method of claim 37, wherein the reducing the kinetic energies includes ionization cooling with hydrogen molecules.

55. The method of claim 54, wherein the storing said some of the desired charged particles includes storing protons and electrons by:
directing the protons and electrons into molecular hydrogen; and
forming additional hydrogen.

56. The method of claim 55, further including fueling a vehicle with some of the hydrogen.

57. The method of claim 37, wherein the reducing the kinetic energies includes reducing the kinetic energies with oxygen molecules.

58. The method of claim 57, wherein the storing said some of the desired charged particles includes storing oxygen ions and electrons: by
directing the protons and electrons into oxygen; and
forming additional oxygen.

59. The apparatus of claim 1, further including at least one solar radiation collector to provide power to the apparatus.

60. The apparatus of claim 1, further including a nuclear energy device to provide power to the apparatus.

61. The apparatus of claim 1, further including a radioisotope decay power source to provide power to the apparatus.
